(19) United States
(12) Patent Application Publication
(10) Pub. No.: US 2009/0275388 A1
(43) Pub. Date: Nov. 5, 2009

(54) Slot Machine

(75) Inventors: Kazumasa Yoshizawa, Tokyo (JP); Arata Ajiro, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/289,038

(22) Filed: Oct. 17, 2008

(30) Foreign Application Priority Data
Oct. 19, 2007 (JP) 2007-272849

(51) Int. Cl. A63F 9/24; A63F 13/00

(52) U.S. Cl. 463/20; 463/30

(57) ABSTRACT

When the free game is started, the main processor displays the doors on the respective symbol display areas, as characters for covering the symbols. Additionally, the processor allows the player to select one symbol for each of the rows from among the 15 symbols positioned after the rotation of the reels has been stopped. Next, the processor changes the remaining symbols not selected to the same kinds of symbols as the selected symbols positioned on the respective rows. Then, the processor awards a prize based on the symbol combination after the symbols have been changed.

### CROSS-REFERENCE TO RELATED APPLICATIONS

This application is based upon and claims a priority from the prior Japanese Patent Application No. 2007-272849 filed on Oct. 19, 2007, the entire contents of which are incorporated herein by reference.

### BACKGROUND

1. Field

The present invention relates to a slot machine in which a plurality of symbols are positioned in a matrix.

2. Description of Related Art

Conventionally, in a slot machine, which is one type of gaming machine, a game is started by inserting coins or the like in the gaming machine. In the game, a symbol column is variably displayed in a predetermined area in the gaming machine, and after the lapse of a predetermined period of time, the symbol column is stopped and displayed. Then, a payout is awarded based on a combination of the symbols thus stopped.

Generally, whether or not a winning combination for which a payout is awarded is established is determined depending on whether a predetermined number of symbols of a same kind (for instance, “CHERRY” and “7”) is positioned along a pay line set in advance. Conventionally, if a predetermined number or more of symbols of a same kind is positioned, a payout is also awarded based on the number of symbols thus positioned, irrespective of the pay line.

In a conventional slot machine, video reels or mechanical reels are employed to display a total of fifteen symbols (3×5). In such a slot machine, when a game is started, the reels are rotated, and in conjunction therewith, the symbols of each column arranged vertically start to vary. Then after every lapse of a predetermined time, the reels are stopped and three symbols in each column are displayed therewith. If the symbols are stopped in a combination in which there are at least a predetermined number of symbols of a same kind, a prize is awarded.

In a conventional slot machine, a lottery of symbols to be positioned in the reels is conducted by random number lottery. This lottery of symbols by random number lottery is conducted by sampling random number values within a predetermined number value range randomly, and then specifying symbols corresponding to the random number values sampled by using a coordinate table prepared in advance. Then, the slot machine controls to stop the reels in such a manner that the specified symbols are positioned. Therefore, symbols to be positioned finally are determined without the intervention of a player's operation.

On the other hand, in a bonus game which is executed if a predetermined condition is satisfied in a base game, a player can make a selection from among alternatives. However, since the prize content is predetermined by random number lottery, the same prizes are awarded regardless of the selection result. Therefore, the prize content will not change by a player's operation.

Further, when executing such a bonus game as described above, which is progressed in accordance with the player's selection from alternatives, different lottery programs and image display control programs must be executed between in a base game and in a bonus game. Thus, the load on a processor has been increased. Moreover, larger memory capacity has been required for storing image data.

It is an object of the present invention to provide a slot machine which allows a player to intervene in determination of the symbols to be finally positioned on a display to thereby raise the player's sense of accomplishment on the game result and to achieve reduction in the load on a processor and the required storage area of a memory.

### SUMMARY

Therefore, in order to achieve the object, according to a slot machine of the present invention encompassing one or more aspects thereof, there is provided a slot machine comprising a display that displays a symbol; an operation unit that accepts a player's operation; and a processor. The processor positions a plurality of symbols in a matrix on the display in such a manner that kinds of the plurality of symbols are invisible. The processor selects any symbol from the plurality of symbols positioned in accordance with the player's operation accepted by the operation unit. The processor changes other symbols positioned on a same row or a same column as a selected symbol to a same kind of symbols as the selected symbol. The processor displays the plurality of symbols positioned on the display in such a manner that kinds of the plurality of symbols are visible. Accordingly, it becomes possible to allow a player's operation to intervene in determination of symbols to be finally positioned on a display. This makes the player feel a sense of accomplishment more with a game result. Additionally, it becomes possible to lighten the load on a processor and miniaturize the required storage area of a memory, compared with the case where a bonus game of conventional selective kind is executed.

According to the present invention encompassing one or more aspects, there is provided a slot machine. The slot machine comprises a display that displays a symbol; an operation unit that accepts a player's operation; and a processor. The processor executes a bonus game if a predetermined condition is satisfied during a base game. The processor positions a plurality of symbols in such a manner that kinds of the plurality of symbols are invisible during the bonus game. The processor selects any symbol from the plurality of symbols positioned, based on the player's operation accepted by the operation unit. The processor changes other symbols positioned on a same row or a same column as a selected symbol to a same kind of symbols as the selected symbol. The processor displays the plurality of symbols positioned on the display in such a manner that kinds of the plurality of symbols are visible. Accordingly, the contents of prize to be given in a free game executed as a bonus game are changed in accordance with the player's operation. As a result, the player feels a sense of accomplishment more with the game result of the bonus game. Additionally, it becomes possible to lighten the load on a processor and miniaturize the required storage area of a memory, compared with the case where a bonus game of conventional selective kind is executed.

Furthermore, according to the present invention encompassing one or more aspects, there is provided a slot machine. The slot machine comprises a display that includes symbol display areas for displaying symbols, the symbol display areas being arranged in a matrix; an operation unit that accepts a player's operation; and a processor. The processor executes a bonus game if a predetermined condition is satisfied during a base game. The processor displays characters for covering the symbol display areas during the bonus game. The processor positions a plurality of symbols on the symbol display areas in such a manner that kinds of the plurality of symbols are invisible, while the symbol display areas are covered with the characters. The processor selects any symbol from the plurality of symbols positioned, based on the player's operation accepted by the operation unit. The processor changes other symbols positioned on a same row or a same column as a selected symbol to a same kind of symbols as the selected symbol. The processor displays the plurality of symbols positioned on the display in such a manner that kinds of the plurality of symbols are visible by making the characters undisplayed. By displaying the characters for covering the symbol display areas, it becomes possible to allow a player to select symbols under the condition that the kinds of symbols are invisible. Thus, even if any symbols that will not bring high-value prize are displayed, the player's sense of expectancy for obtaining high-value prize is raised.

### BRIEF DESCRIPTION OF THE DRAWINGS

The accompanying drawings, which are incorporated in and constitute a part of this specification, illustrate embodiments of the invention and, together with the description, serve to explain the objects, advantages and principles of the invention.

FIG. 1 is an explanatory view showing a characteristic part of a slot machine according to one embodiment of the present invention;

FIG. 2 is a perspective view showing an outer appearance of a slot machine according to one embodiment of the present invention;

FIG. 3 is a front view showing a symbol display portion of a slot machine according to one embodiment of the present invention;

FIG. 4 shows a symbol column arranged on each reel during a base game or a free game in a slot machine according to one embodiment of the present invention;

FIG. 5 is a view showing a list of contents for various symbols and payouts which are employed in a slot machine according to one embodiment of the present invention;

FIG. 6 is a block diagram showing an internal configuration of an entire slot machine according to one embodiment of the present invention;

FIG. 7 is a block diagram showing an internal configuration of, specifically, a sub-control board in a slot machine according to one embodiment of the present invention;

FIG. 8 is an explanatory view showing a base game and a free game which are executed in a slot machine according to one embodiment of the present invention;

FIG. 9 is an explanatory view showing changing form of a symbol based on the player's operation in a free game according to one embodiment of the present invention;

FIG. 10 is a flowchart showing a main control process program executed in the slot machine according to one embodiment of the present invention;

FIG. 11 is a flowchart showing a main game process program executed in the slot machine according to one embodiment of the present invention;

FIG. 12 is a flowchart showing a free game process program executed in the slot machine according to one embodiment of the present invention;

FIG. 13 is a perspective view showing an outer appearance of a slot machine according to another embodiment of the present invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A slot machine according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Next, a detailed description will be given on an embodiment relating to a slot machine according to the present invention, while referring to the accompanying drawings. The slot machine according to the present embodiment to be described hereinafter is a so-called video slot machine which has an image display device such as a liquid crystal display and in which a game is executed by displaying various kinds of symbol image on the image display device.

The slot machine according to the present invention executes two types of games: a base game which is executed with consuming a gaming value corresponding to the bet amount placed by a player; and a free game (bonus game) which is executed without consuming a gaming value. Also, in a free game, symbols once positioned are replaced with other symbols in accordance with the player's selection operation.

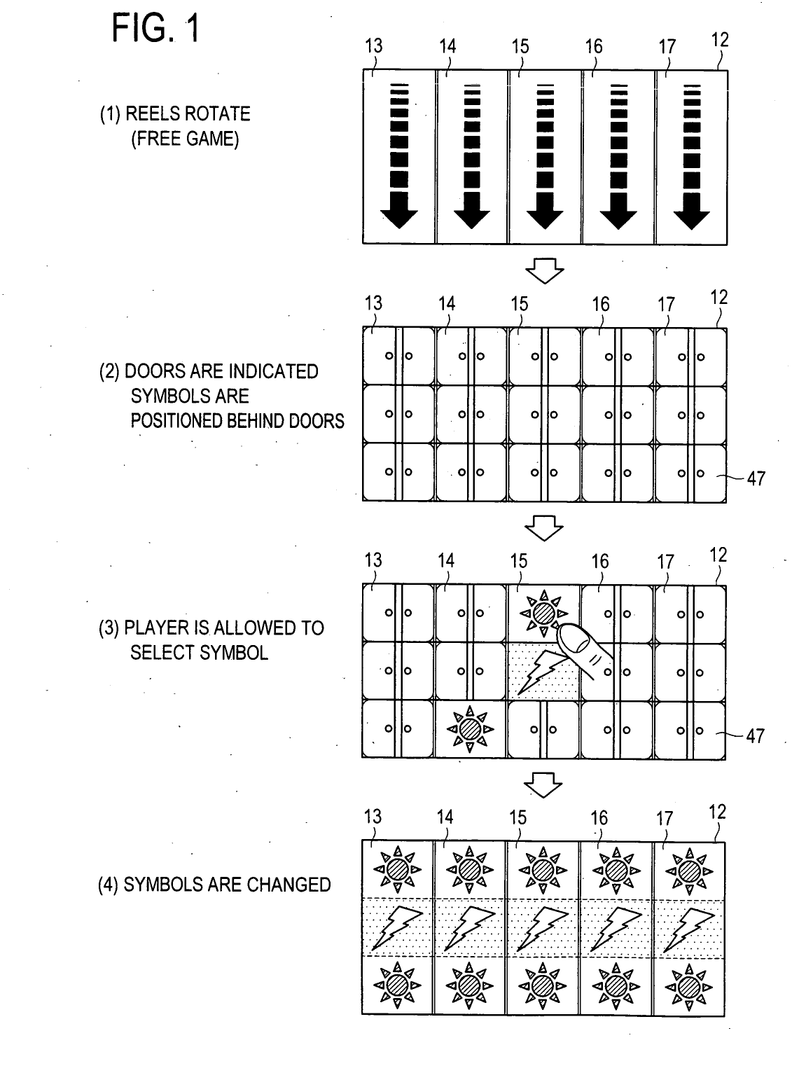

For instance, FIG. 1 shows an example in which the present invention is applied to a slot machine having five reels 13 to 17 provided on a display. If a predetermined condition is satisfied in the slot machine during a base game, a free game is executed instead of the base game.

When the free game is started, the reels 13 to 17 start rotating and symbol strings on the respective reels 13 to 17 are displayed in a scrolled manner. Next, doors 47 in a closed state are overlaid and displayed on respective 15 symbol display areas during the symbol strings being scrolled. The displayed doors 47 cover the symbols being scrolled so that the symbols become invisible to the player.

Then, after the lapse of a predetermined period of time, the reels 13 to 17 stop rotating in turn, starting from left, and the 15 symbols are displayed on the respective symbol display areas. It is to be noted that the kinds of positioned symbols are invisible to the player covered by the doors 47.

After the reels 13 to 17 stop rotating and the symbols are displayed on the respective symbol display areas, the player is allowed to select one symbol for each of the rows, from among the 15 symbols covered with the doors 47. Next, only the doors 47 that cover the three symbols selected by the player are opened (that is, undisplayed), so that the selected three symbols become visible. Incidentally, the symbol positioning in a vertical direction is referred to as column and the symbol positioning in a horizontal direction is referred to as row.

The remaining 12 symbols, which were not selected by the player, are changed with respect to each row to the same kinds of symbols as the selected symbols positioned on the respective rows. After that, the doors 47 that cover the remaining symbols not selected by the player are opened, so that all the positioned symbols become visible. As a result, the positioned symbols display on the display in such a manner that kinds of the symbols are visible. Then, a prize of the free game is awarded based on the combination of positioned symbols.

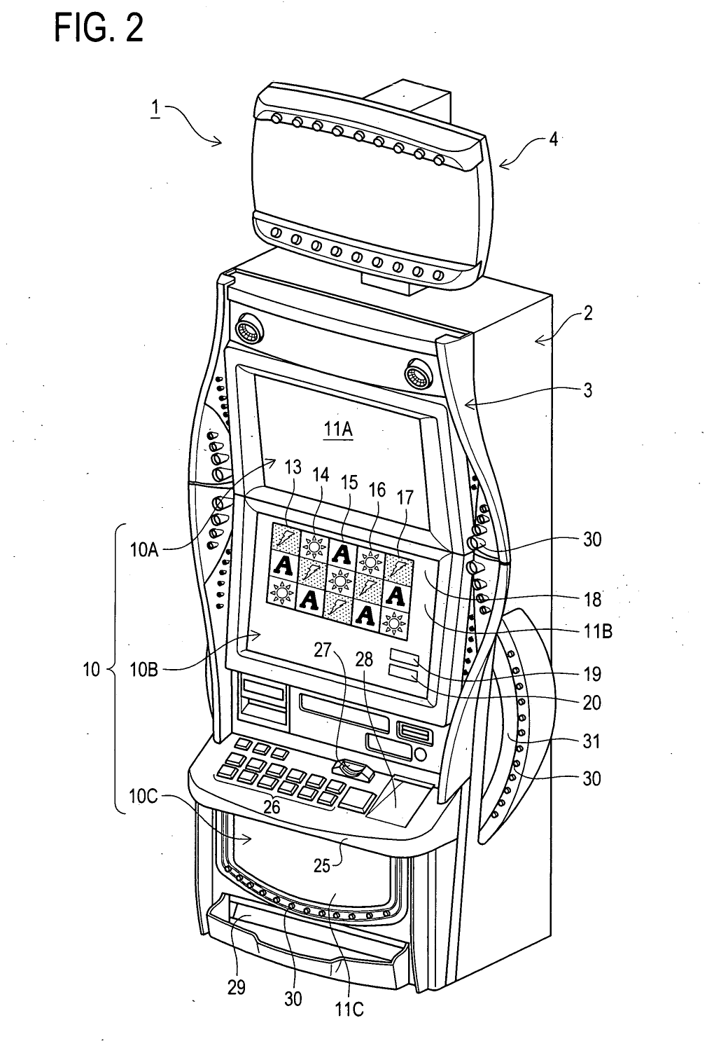

Hereinafter, a schematic configuration of the slot machine 1 according to the present embodiment will be described based on FIG. 2. FIG. 2 is a perspective view showing an outer appearance of the slot machine 1 according to the present embodiment.

The slot machine 1 according to the present embodiment is an upright-type slot machine installed in a gaming arcade such as a casino or the like. This slot machine 1 has a cabinet 2, a main door 3 provided at a front face of the cabinet 2, and a topper effect device 4 arranged at an upper side of the cabinet 2.

The cabinet 2 is a housing portion that houses electrical or mechanical components. These electrical or mechanical components are used in execution of a predetermined game aspect.

The main door 3 has an upper display portion 10A, a mid-stage variable display portion 10B and a lower display portion 10C, functioning as a display portion 10 that displays information with respect to the game. The upper display portion 10A has an upper liquid crystal panel 11A which is arranged at an upper side of the variable display portion 10B. The upper liquid crystal panel 11A displays, for instance, effect images, an introduction to the game contents, explanation of game rules, payout tables, a sub game result to be later described and the like. The lower display portion 10C is arranged at a lower side of the variable display portion 10B and has a plastic panel 11C onto which an image has been printed. This plastic panel 11C is lit up with a backlight.

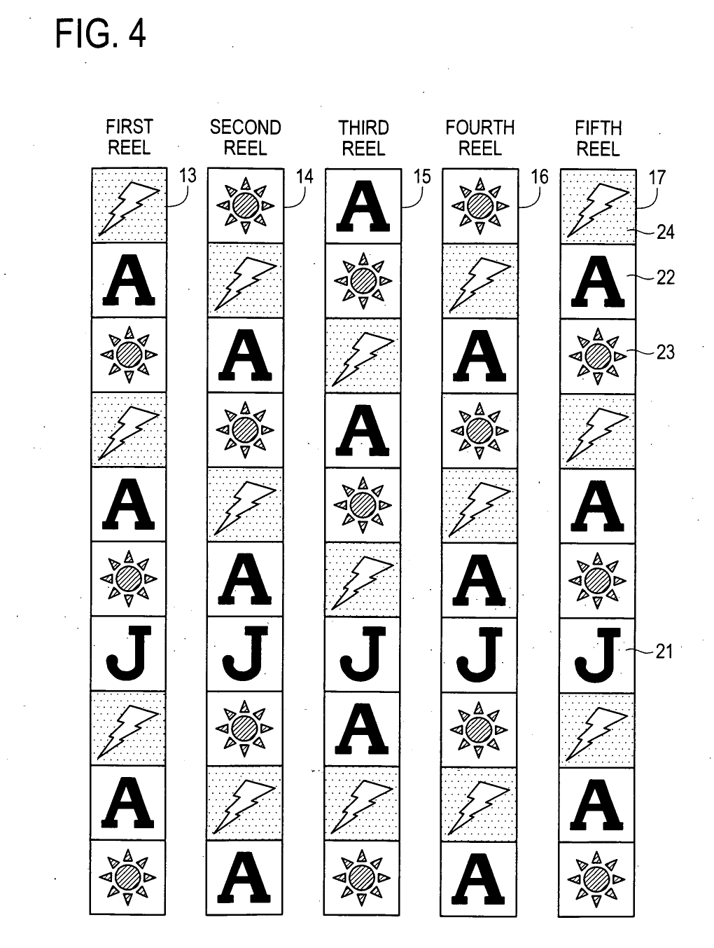

The variable display portion 10B that displays an execution state of the game has a main liquid crystal panel 11B constituted of a heretofore known transparent liquid crystal panel which is fixedly mounted to the main door 3. Here, the main liquid crystal panel 11B is constituted of a heretofore known liquid crystal panel and has a symbol display portion 12 which comprises a 3×5 symbol display area. The symbol display portion 12 is constituted of five reels 13 through 17. With respect to the respective reels 13 through 17, the symbol columns with the alignment set in advance (FIG. 4) are displayed in a scrolled manner during a base game and a free game, and after the lapse of a predetermined period of time, three symbols are respectively stopped and displayed in each reel. As a result, fifteen symbols are displayed in accordance with the progress of the game as will be described later, and a predetermined payout is awarded to the player in accordance with the combination of the displayed symbols and the credit amount (bet amount) thus betted. The number of reels may be three, and further, the number of displayed symbols is not limited to fifteen.

Particularly during a free game, 15 doors 47 are displayed that cover the 3×5 symbol display areas and make the symbols invisible.

Further, a touch panel 18 is provided at a front face of the main liquid crystal panel 11B. The player can operate the touch panel 18 to input various types of commands. Particularly in this embodiment, the touch panel 18 is used for selection of symbols positioned on the symbol display portion 12 during a free game.

At a right lower side of the variable portion 10B there are provided a payout amount display portion 19 and a credit amount display portion 20. The payout amount display portion 19 displays, as a payout amount, a payout amount to be awarded in a case where the symbol combination which is stopped and displayed on the pay line in a base game is a predetermined combination, and an accumulated payout amount acquired in a free game. The credit amount display portion 20 displays the credit amount that the player currently possesses.

The cabinet 2 has an operation table 25 provided at a front face thereof, between the variable display portion 10B and the lower display portion 10C, and bulging out at the front side. On this operation table 25 are arranged various kinds of operation buttons 26, forming an operation unit that commands execution of the game. The buttons 26 include a BET button, a COLLECT button, a START button, a CASHOUT button and the like. The operation table 25 has a coin slot 27 adapted to accept coins, representing gaming values, inside the cabinet 2, and a bill slot 28 adapted to accept bills inside the cabinet 2.

The slot machine 1 according to the present embodiment employs coins, bills or electronic value information (credit) corresponding to these, as gaming values. The gaming values applicable to the present invention are not limited to those described above, and can include, for instance, medals, tokens, electronic money and tickets.

At a lowermost part of the cabinet 2, there is provided a coin tray 29 adapted to accept coins paid out from the hopper. Further, at a periphery of the cabinet 2 in the slot machine 1, there is arranged a light emitting portion 30 which lights up in a predetermined lighting fashion during a free game, or if a win occurs. Further, at a side face of the cabinet 2 is provided a speaker 31 for audio output.

Further, the slot machine 1 has a topper effect device 4 provided at an upper side of the cabinet 2. This topper effect device 4 has a rectangular board shape and is arranged so as to be substantially parallel with the upper liquid crystal panel 11A of the upper display portion 10A.

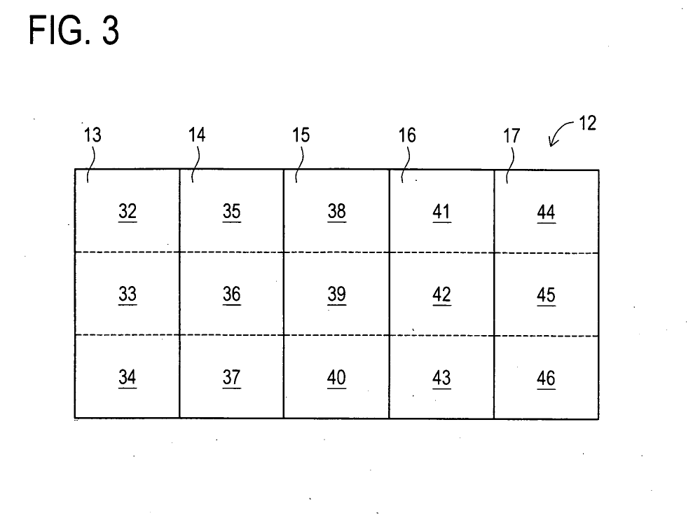

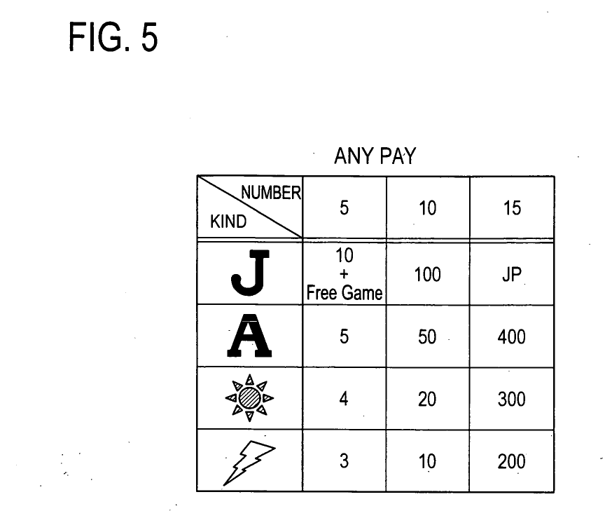

Next, a symbol display portion 12 provided in the main liquid crystal panel 11B and symbols 21 through 24 to be displayed on the symbol display portion 12 will be described based on FIG. 3 through FIG. 5. FIG. 3 is a front view showing a symbol display portion 12 in a slot machine according to the present embodiment. FIG. 4 shows a symbol column arranged on each reel in a slot machine according to the present embodiment of the present invention. FIG. 5 is a view showing a list of contents for various symbols and payouts which are used during a game and free game in a slot machine according to the present embodiment of the present invention.

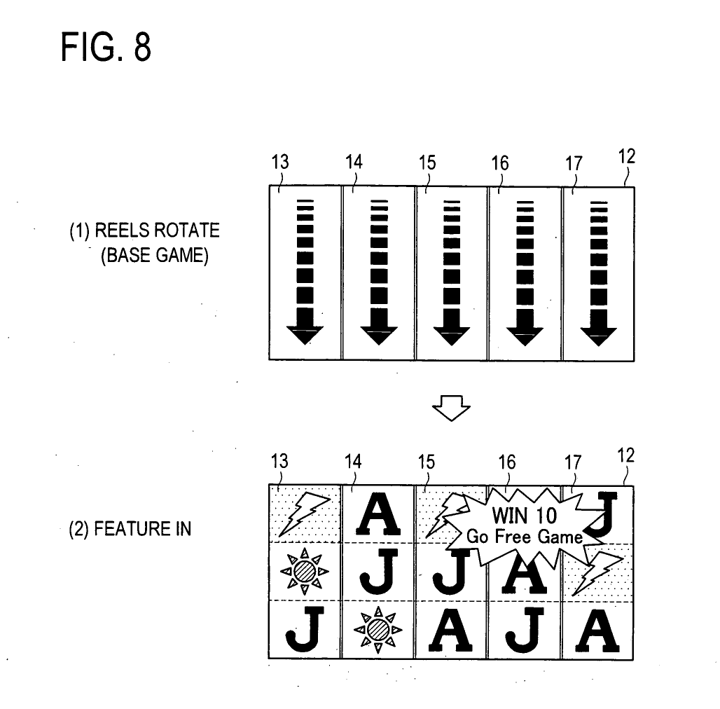

First, there will be described the symbol display portion 12 and symbols 21 through 24 displayed on the symbol display portion 12 during the execution of the base game. The symbol display area 12 in the base game, according to the present embodiment, is constituted of five reels 13 through 17. The reels 13 through 17 have symbol display areas 32 through 46, each symbol display area respectively displaying three symbols when the respective rotating reels 13 through 17 are stopped. In the present embodiment, there are used only four kinds of symbols: “JACK” symbol 21; “ACE” symbol 22; “SUN” symbol 23; and “THUNDER” symbol 24. All of those four kinds of symbols are four kinds of scatter symbols. When a game is started, the respective symbol display areas 32 through 46 each display one symbol (total fifteen symbols), as shown at (1) through (2) in FIG. 8. In the drawing, a dotted line is drawn to divide the respective symbol display areas 32 through 46, however, a configuration is possible where the dotted line is not shown.

Next, the symbol columns displayed in a scrolled manner with the rotation of the reels 13 through 17 at the slot machine according to the present embodiment will be described.

As shown in FIG. 4, each of the reels 13 through 17 is comprised of ten symbols, namely, one “JACK” symbol 21, three “ACE” symbols 22, three “SUN” symbols 23, and three “THUNDER” symbols 24.

Regarding respective symbol columns on the reels 13 through 17, a code number is assigned to each of the symbols in order from top one and code numbers are used in a lottery process so as to determine symbols to be positioned in the symbol display areas 32 through 46.

Next, there will be described winning combinations determined with respective symbols 21 through 24 stopped and displayed on the symbol display portion 12, by referring to FIG. 5.

One “JACK” symbol 21 is included in each of the symbol columns on the reels 13 through 17. If five “JACK” symbols 21 are positioned on any areas of the symbol display areas 32 through 46, 10 credits are paid as a payout and predetermined number (e.g., five) of free games are executed in subsequent to termination of a base game as another payout. If ten “JACK” symbols 21 are positioned on any areas of the symbol display areas 32 through 46, 100 credits are paid as a payout. If fifteen “JACK” symbols 21 are positioned on any areas of the symbol display areas 32 through 46, credits currently accumulated as Jack Pot are paid out.

Three “ACE” symbols 22 are included in each of the symbol columns on the reels 13 thorough 17. If five or more of “ACE” symbols 22 are positioned on any areas of the symbol display areas 32 through 46, one of the payouts as shown in FIG. 5 is paid.

Three “SUN” symbols 23 and three “THUNDER” symbols 24 each are included in each of the symbol columns on the reels 13 thorough 17. If four or more of “SUN” symbols 23 are positioned on any areas of the symbol display areas 32 through 46, one of the payouts as shown in FIG. 4 is paid. If three or more of “THUNDER” symbols 24 are positioned on any of the symbol display areas 32 through 46, one of the payouts as shown in FIG. 5 is paid.

It is to be noted that the payout table shown in FIG. 5 indicates payouts in case the bet amount placed at the beginning of a game is one. Therefore, in case the bet amount is two or more, there is paid out amount corresponding to the product of a payout multiplied by the bet amount.

In the present embodiment, a winning combination is established if the same kind of symbol is displayed by a predetermined number of times in the symbol display areas 32 through 46 irrespective of the pay line, and in a case only scatter symbols have been constituting symbols. In this case, a payout is awarded. A payout may also be awarded for a win according to a pay line. In that case, a payout may be awarded if the same kind of symbol is displayed by a predetermined number of times along the pay line. Also, both a payout depending on the pay line and a payout irrespective of the pay line may be awarded.

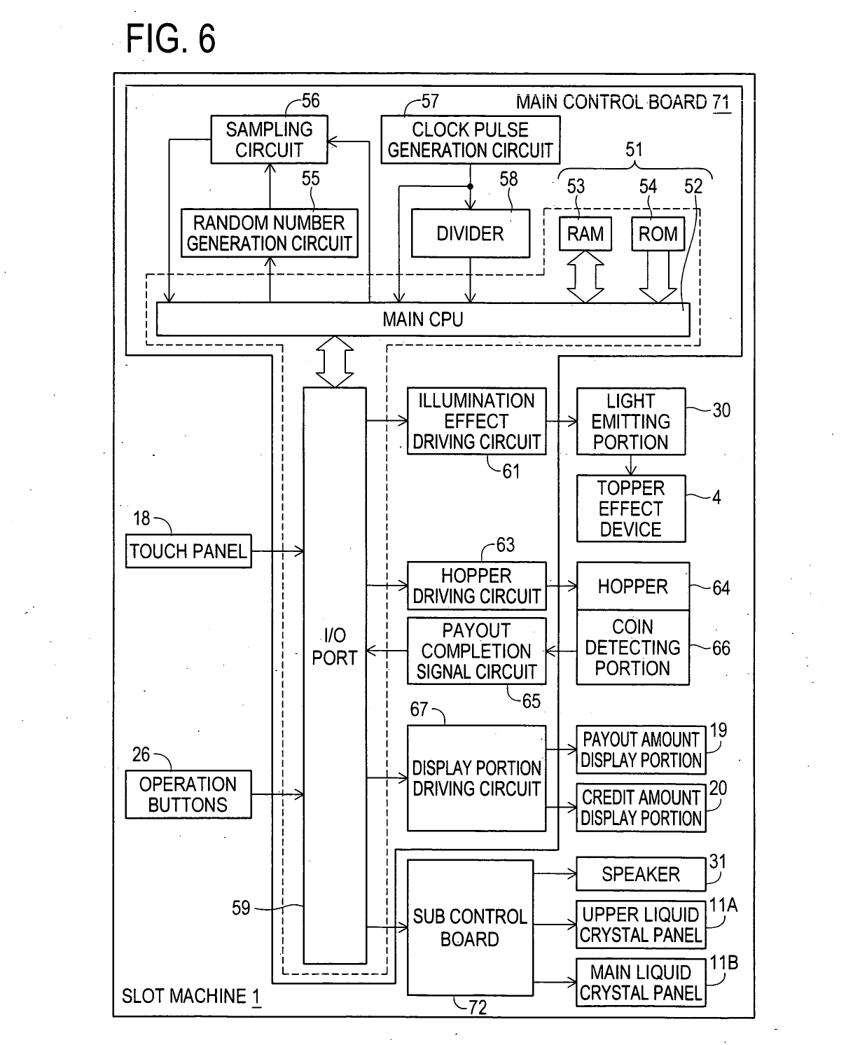

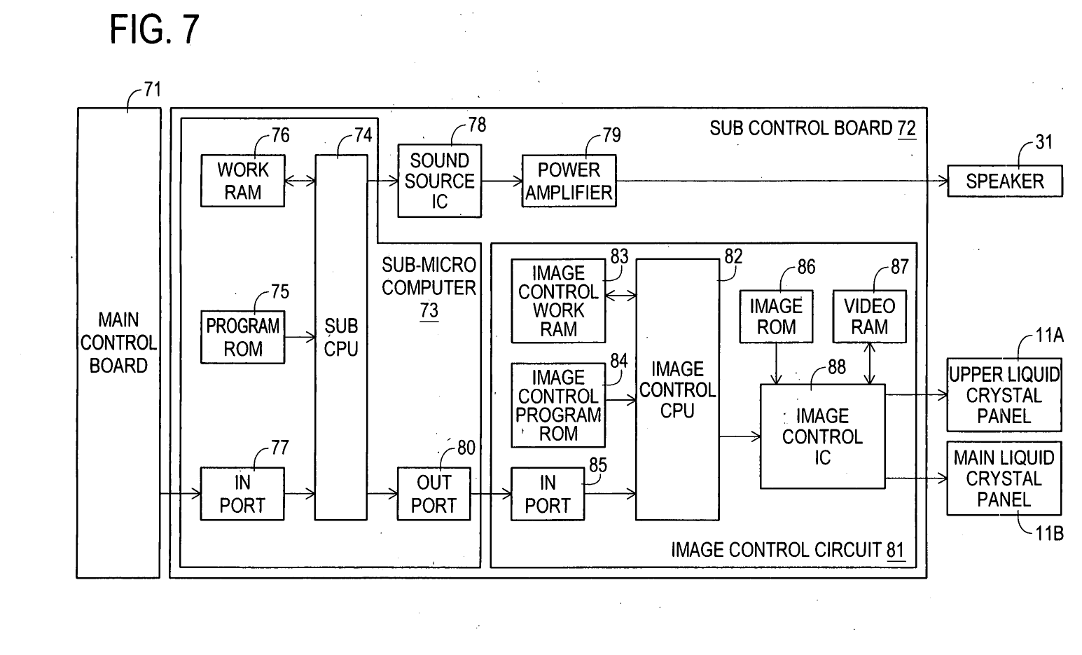

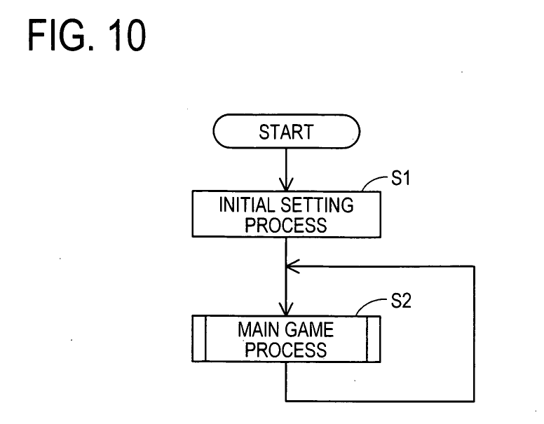

Next, the internal configuration of the above-mentioned slot machine 1 will be described while referring to FIG. 6 and FIG. 7. FIG. 6 is a block diagram showing an internal configuration of the entire slot machine 1. As shown in FIG. 6, the slot machine 1 has a plurality of constituent elements arranged around a main control board 71 including a controller 51 that executes control programs that will be described later (FIG. 10 through FIG. 19). The main control board 71 has a controller 51, a random number generation circuit 55, a sampling circuit 56, a clock pulse generation circuit 57, a divider 58, an illumination effect driving circuit 61, a hopper driving circuit 63, a payout completion signal circuit 65 and a display portion driving circuit 67.

The controller 51 has a main CPU 52, a RAM 53 and a ROM 54. The main CPU 52 operates in accordance with the programs stored in the ROM 54 and performs signal input and output with respect to the other constituent elements through an I/O port 59. Specifically, the main CPU 53 controls the operation of the entire slot machine 1. The RAM 53 stores data and programs to be used when the main CPU 52 is operating. For instance, the RAM 53 temporarily retains the random number values which have been sampled by the sampling circuit 56 after the game has started. The RAM 53 stores code numbers corresponding to the respective reels 13 through 17. The ROM 54 stores various types of programs that will be executed by the main CPU 52, as well as permanent data.

More particularly, the programs stored in the ROM 54 include game programs and game system programs (hereinafter referred to as game programs or the like). Further, the game programs include lottery programs as will be described later.

The lottery programs are used to determine the code numbers for the respective reels 13 through 17 corresponding to the respective symbols which are re-positioned on the main liquid crystal panel 11B. This lottery program includes symbol weighing data for each of the respective five reels 13 through 17. The symbol weighing data shows correspondence relationships between the respective code numbers and one or a plurality of random number values within a predetermined number value range (for instance 0 through 255). The probability of lottery with respect to each symbol is set by associating one or a plurality of random number values to one code number. The random number values are drawn by lottery and symbols which have been finally identified from the random number values are re-positioned on the main liquid crystal panel 11B.

The lottery program for determining the symbols to be positioned may also employ weighing data in which the predetermined random number range is associated to the symbol combination. In this case, first, the symbol combination is selected by lottery based on the lottery program, and thereafter, the symbol combination thus determined is re-positioned in the main liquid crystal panel 11B.

The random number generation circuit 55 operates in accordance with the commands from the main CPU 52 and generates random numbers within a predetermined range. The sampling circuit 56 selects, by lottery, an arbitrary random number from the random numbers generated by the random number generation circuit 55 in response to a command from the main CPU 52. At the same time, the sampling circuit 56 inputs the random number thus selected to the main CPU 52. The clock pulse generation circuit 57 generates a reference clock for causing the main CPU 52 to operate. The divider 58 inputs a signal obtained by dividing the reference clock by a constant frequency to the main CPU 52.

The main control board 71 is connected to the touch panel 18. The touch panel 18 is arranged at a front face of the main liquid crystal panel 11B and is adapted to identify a coordinate position of the portion that was touched by the player. Specifically, the touch panel 18 can discriminate the portion that the player has touched, and in what direction the touched portion was moved based on the coordinate position information that was thus identified. A signal in accordance with the above discrimination is then inputted to the main CPU 52 through the I/O port 59.

The main control board 71 is connected to the operation buttons 26, including a START button for commanding execution of a game, a COLLECT button, a BET button and the like. Accordingly, a signal in accordance with a depression operation of these buttons is inputted to the main CPU 52 through the I/O port 59.

The illumination effect driving circuit 61 outputs an effect signal for causing the light emitting portion 30 and the topper effect device 4 as mentioned above to perform illumination effects. The topper effect device 4 is connected in series with the illumination effect driving circuit 61 through the light emitting portion 30.

The hopper driving circuit 63 drives the hopper 64 under the control of the main CPU 52. As a result, the hopper 64 carries out an operation to payout coins to the coin tray 29. The payout completion signal circuit 65 receives coin amount value data from the coin detecting portion 24 to which it is connected. Then, when the received coin amount value has reached the set coin amount value, the payout completion signal circuit 65 inputs a signal that notifies the completion of coin payout to the main CPU 52. The coin detecting portion 66 detects the number of coins that were paid out by the hopper 64 and then inputs coin amount value data showing the amount of coins that was detected to the payout completion signal circuit 65. The display portion driving circuit 67 controls the display operation of the respective display portions including the reels 13 through 17, a payout amount display portion 19 and the credit amount display portion 20 and the like.

The main control board 71 is connected to the sub-control board 72. As shown in FIG. 7, the sub-control board 72 carries out display control of the upper liquid crystal panel 11A in the upper display portion 10A and the main liquid crystal panel 11B in the variable display portion 10B, as well as output control of the audio outputted by the speaker 31, based on the commands received from the main control board 71. This sub-control board 72 is constituted on a separate circuit board from the circuit board that constitutes the main control board 71. The sub-control board 72 has a micro computer (hereinafter referred to as “sub-micro computer”) 73 which is provided as a main constituting element. Then, the sub-control board 72 has a sound source IC 78, a power amplifier 79, and an image control circuit 81. The sound source IC 78 controls the audio output from the speaker 31. The power amplifier 79 functions as an amplifier. The image control circuit 81 operates as a display control section for the upper liquid crystal panel 11A and the main liquid crystal panel 11B.

The sub-micro computer 73 has a sub-CPU 74, a program ROM 75, a work RAM 76 and I/O ports 77 and 80. The sub-CPU 74 carries out a control operation in accordance with a control command transmitted from the main control board 71. Although the sub-control board 72 does not have a clock pulse generation circuit, a divider, a random number generation circuit and a sampling circuit, it is constituted so as to execute sampling of random numbers based on an operation program of the sub-CPU 74. The program ROM 75 stores a control program to be executed by the sub-CPU 74. The work RAM 76 is constituted as a temporary memory to be used by the sub CPU 74 in executing the control program.

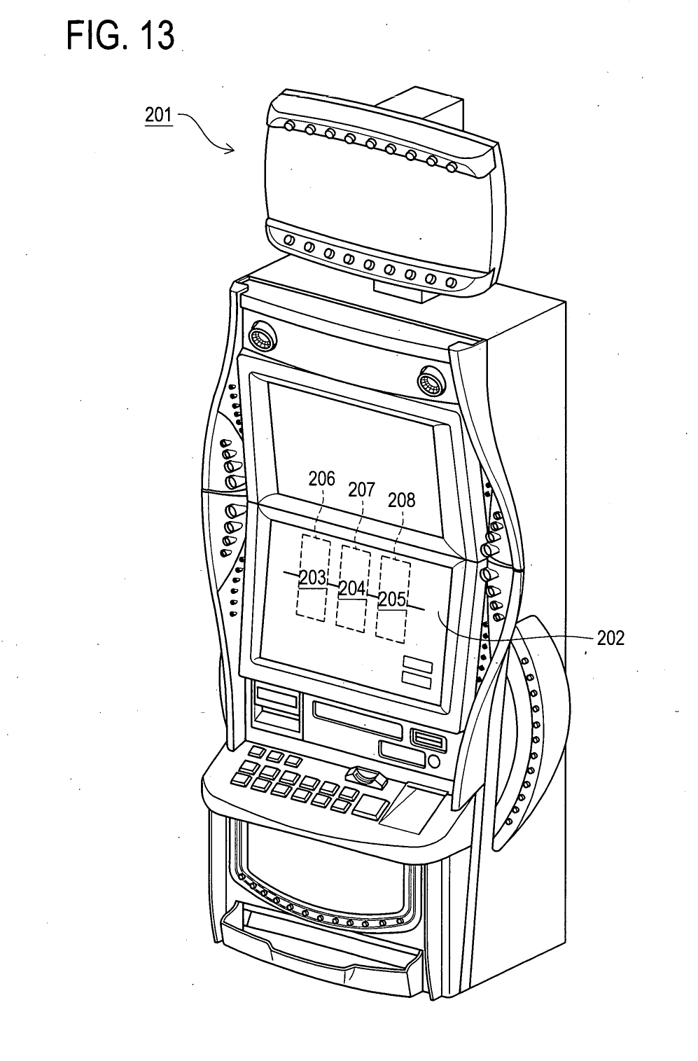

The image control circuit 81 has an image control CPU 82, an image control work RAM 83, an image control program ROM 84, an image ROM 86, a video RAM 87 and an image control IC 88. The image control CPU 82 determines the image to be displayed on the upper liquid crystal panel 11A and the main liquid crystal panel 11B based on the parameters set in the sub-micro computer 73 and the image control programs stored in the image control program ROM 84. For instance, the upper liquid crystal panel 11A displays a payout table, a help screen and a sub game result screen (FIG. 13). The main liquid crystal panel 11B carries out scrolled display and stopped display of the respective symbols 21 through 24 concurrent with the rotation of the reels 13 through 17 in a base game and free game, with respect to the symbol display portion 12.

The image control program ROM 84 stores an image control program and various types of selection tables relating to display on the upper liquid crystal panel 11A and the main liquid crystal panel 11B. The image control work RAM 83 functions as a temporary memory to be used in execution of the image control program in the image control CPU 82. The image control IC 88 forms an image in accordance with the contents determined by the image control CPU 82 and then outputs the image thus formed to the upper liquid crystal panel 11A and the main liquid crystal panel 11B.

The image ROM 86 stores dot data for forming an image. The video RAM 87 functions as a temporary memory to be used by the image control IC 88 in forming an image.

Next, the base game and the free game which are carried out in the slot machine 1 having the above configuration will be described by referring to FIG. 8. First, the base game will be described. The base game is a slot game in which a predetermined symbol combination is repositioned on the main liquid crystal panel 11B, through the respective reels 13 through 17. More specifically, the player operates the operation button 26 to set the bet amount, and when he/she depresses the START button, a lottery process is executed to select, by lottery, the symbols that will be positioned in the symbol display portion 12. After the start button has been depressed and the reels 13 through 17 start rotating following the lapse of a predetermined period of time, the symbol columns are displayed in a scrolled manner (refer to FIG. 8 (1)). On the reels 13 through 17 there are arranged the respective symbols 21 through 24 in an alignment shown in FIG. 4. Then, after the lapse of a predetermined period of time, a total of fifteen symbols will be sequentially stopped and displayed in the symbol display areas 32 through 46, as shown in FIG. 8 (2).

Here, in the base game, various kinds of winning combinations are determined in advance based on the respective symbol combination re-positioned in the main liquid crystal panel 11B (see FIG. 5). If a symbol combination corresponding to the winning combination is realized through the symbols re-positioned in the symbol display areas 32 through 46, a gaming value obtained by multiplying the payout corresponding to the winning combination thus established by the bet amount is awarded to the player.

On the other hand, the free game carried out in the slot machine executed after the game mode has switched from the base game in a case where a winning combination, including five “JACK” symbols 21, has been positioned in the symbol display areas 32 through 46. After the game has been successively carried out by a predetermined number of times (for instance, five times), the free game terminates and the game mode switches again to the base game. With respect to the procedure of the game, the free game is the same as the base game, except that in the free game, gaming values (credits) corresponding to the bet amount are not consumed at the start of the game, and the game is continuously carried out automatically without requiring the player to operate the operation button 26. However, in the free game, the doors 47 in a closed state are overlaid and displayed on the 15 symbol display areas 32 to 46 during the symbol strings being scrolled. Next, the displayed doors 47 cover the symbols being scrolled so that the symbols become invisible to the player (see (2) in FIG. 1).

With the lapse of a predetermined period of time, 15 symbols in total are stopped and displayed on the respective symbol display areas 32 to 46 in a phased manner, similar to the base game. However, the kinds of symbols positioned are invisible to the player by the doors 47.

After the symbols are positioned on the respective symbol display areas 32 to 46, the player is allowed to select one symbol for each of the rows, from among the 15 symbols covered with the doors 47. Next, only the doors 47 that cover the three symbols selected by the player are undisplayed so that the selected three symbols become visible (see (3) in FIG. 1).

The remaining 12 symbols, which were not selected by the player, are changed with respect to each row to the same kinds of symbols as the selected symbols positioned on the respective rows (see (4) in FIG. 1). After that, the doors 47 that cover the remaining symbols not selected by the player are undisplayed, so that all the symbols positioned become visible. If a symbol combination corresponding to a winning combination is realized by the symbols positioned on the symbol display areas 32 to 46, a payout corresponding to the realized winning combination is awarded to the player.

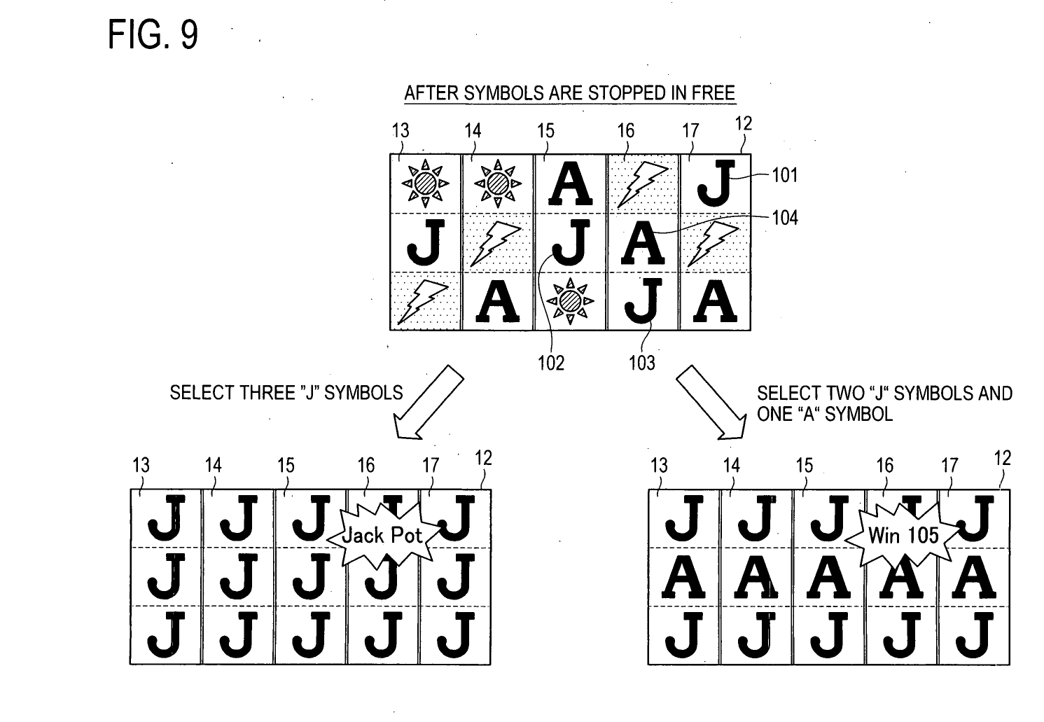

Therefore, for instance, if the symbols are stopped and displayed in the combination as shown in the upper part of FIG. 9, “JACK” symbols 21 are positioned on all the symbol display areas 32 to 46 when the player selects a “JACK” symbol 101 on the upper row, a “JACK” symbol 102 on the middle row, and a “JACK” symbol 103 on the lower row. Consequently, the prize corresponding to Jack Pot is paid out.

On the other hand, if the player selects the “JACK” symbol 101 on the upper row, an “ACE” symbol 104 on the middle row and the “JACK” symbol 103 on the lower row, ten “JACK” symbols 21 and five “ACE” symbols 22 are positioned on the symbol display areas 32 to 46. Consequently, 105 credits are paid out.

In this manner, as shown in FIG. 9, a symbol combination to be positioned finally changes in accordance with the selection result by a player in a free game. Along with this, prize contents to be awarded to the player changes.

Next, a main control program to be executed in the slot machine 1 according to the present embodiment will be described in detail while referring to the drawings. FIG. 10 is a flow chart showing a main control program.

First, when the power switch is turned on (upon power on), the main control board 71 activates the sub-control board 72 and the controller 51 executes an initial setting process at step (hereinafter abbreviated as S) 1. In the initial setting process, the main CPU 52 executes the BIOS stored in the ROM 54 and expands the compressed data incorporated in the BIOS in the RAM 53. In executing the BIOS that was expanded in the RAM 53, the main CPU 52 carries out a diagnosis and initialization of the different types of peripheral devices. Further, the main CPU 52 writes the game programs and the like from the ROM 54 into the RAM 53 to acquire payout rate setting data and country identification information. While executing the initial setting process, the main CPU 52 also carries out an authentication process with respect to each program.

Then, at S2, the main CPU 52 sequentially reads the game programs and the like from the RAM 53 and executes these programs to carry out a main game process. The slot machine 1 according to the present embodiment carries out the game by executing this main game process. The main game process is repeatedly executed while power is supplied to the slot machine 1.

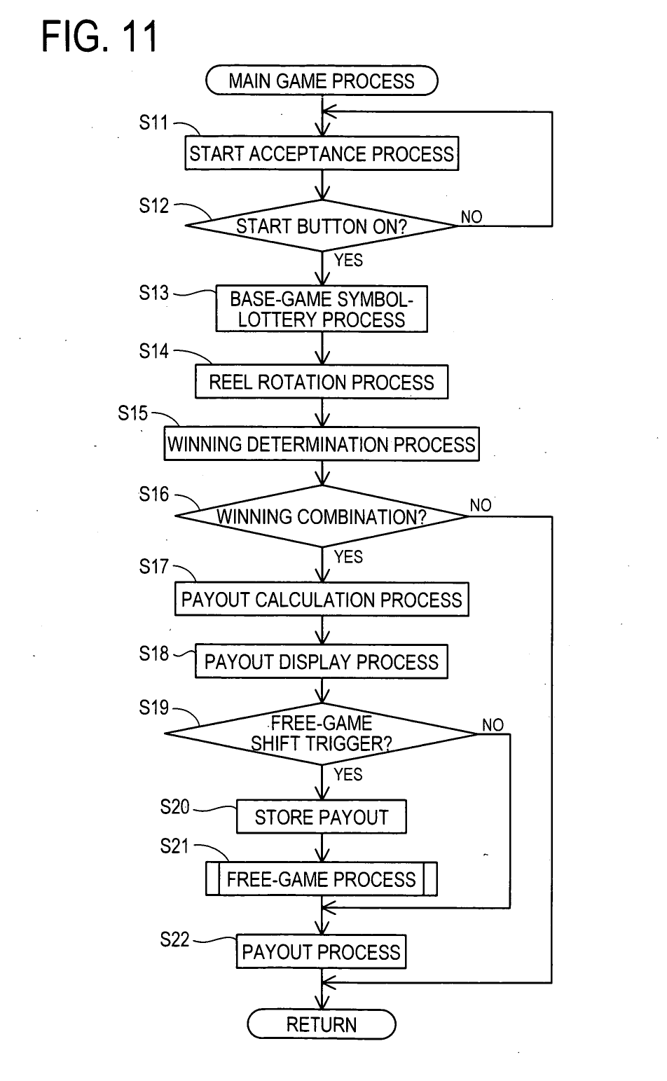

Next, a sub-process of the main game process at the above-described S2 will now be described based on FIG. 10. FIG. 10 is a flow chart of a main game process program to be executed in the slot machine 1 according to the present embodiment. The programs shown in the flow charts at FIG. 10 and FIG. 11 as will be described later are stored in the ROM 54 and RAM 53 provided in the slot machine 1 and are executed in the main CPU 52.

As shown in FIG. 11, the main CPU 52 first executes a start acceptance process at S11. In the start acceptance process, the player inserts coins and places a bet using the BET button from amongst the operation buttons 26.

At S12, the main CPU 52 determines whether or not the start button from amongst the operation buttons 26 has been depressed. This determination is carried out based on the signal inputted to the main CPU 52 in response to depression of the start button. Here, if the start button has not been depressed (S12: NO), the flow returns to the start acceptance process (S11). As a result, the player can carry out an operation to correct, etc. the bet amount. Alternatively, if the start button has been depressed (S12: YES), the main CPU 52 subtracts the bet amount set based on the above-described bet operation from the credit amount that the player currently possesses and at the same time stores the result as bet information in the RAM 53.

At step S13, the main CPU 52 executes a symbol lottery process for the base game. In this symbol lottery process, the main CPU 52 selects, by lottery, the symbols to be positioned on the main liquid crystal panel 11B. More specifically, the main CPU 52 executes the lottery program stored in the RAM 53, there by sampling a random number value from a number value range within a predetermined random number value range. The main CPU 52 determines the respective fifteen symbols (specifically, stop position of reels 13 through 17), from amongst the four kinds of scatter symbols 21 through 24, that will be re-positioned in the symbol display areas 32 through 46, based on the sampled random number value and the symbol weighing data.

Next, at S14, the main CPU 52 carries out a reel rotation process. Namely, the reels 13 through 17 start rotating and the symbol columns positioned in the respective reels 13 through 17 are displayed in a scrolled manner at a predetermined speed. Then, after the lapse of a predetermined period of time, the rotating reels 13 through 17 are stopped in turn, starting from the left, and one symbol is respectively displayed in each of symbol display areas 32 through 46 (refer to FIG. 8 (2)). Thus, the symbol combination determined at the above-mentioned S13 is re-positioned in the symbol display areas 32 through 46 of the main liquid crystal panel 11B.

Then, at S15, the main CPU 52 carries out a winning determination process to determine whether the symbol combination positioned in the main liquid crystal panel 11B is any of the winning combinations for which a payout is awarded. This determination is carried out based on the code numbers of the respective reels 13 through 17 stored in the RAM 53.

If it is determined, at the above-mentioned S15 that the winning combination has been established (S16: YES), the flow shifts to S17. Alternatively, if it is determined that the winning combination has not been established (S16: NO), the main game process is ended. The processes following S11 are again carried out in a case a game is next started.

At S17, the main CPU 52 calculates a payout based on the winning combination thus established. For instance, if a predetermined number or more of the same kind of symbols have been positioned, as shown in FIG. 5, a payout is calculated in accordance with the kind of symbol and the number of positioned symbols.

Next, at step S18, the main CPU 52 notifies the player by displaying the kind of the winning combination thus established and the contents of the payout with respect to the main liquid crystal-panel 11B. For instance, if five “JACK” symbols 21 have been indicated, a message “WIN 10” and a message “Go Free Game” are displayed, as shown in FIG. 8(2). The former message notifies that 10 credits will be paid out as a payout, and the latter message notifies that the game mode shifts to a free game.

Next, at step S19, the main CPU 52 determines whether or not the trigger for shifting to the free game has been established. More specifically, if the winning combination including five “JACK” symbols 21 has been established, a determination is made that the trigger for shifting to the free game has been established.

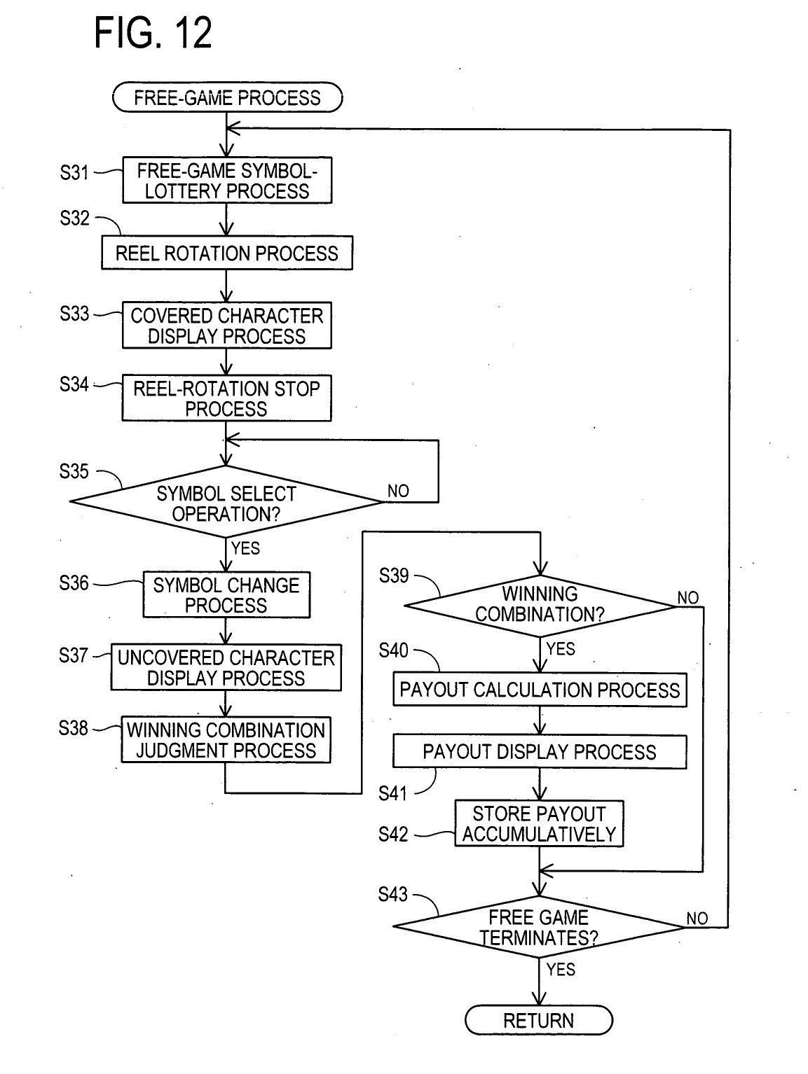

As a result, if it is determined that the free-game shift trigger has been established (S19: YES), the value for the payout which will be awarded at present is stored (S20), and then, the flow shifts to the free game process (FIG. 12) as will be described later (S21). The payout which is stored at the above-described step S20 will be paid out at a payout process (S22) altogether with other payouts. Alternatively, if it is determined that the free-game shift trigger is not established (S19: NO), the flow shifts to step S22.

At step S22, the main CPU 52 awards a payout to the player in accordance with the winning combination established in the current game, based on the calculation result of the above-described step S17. At this time, the payout can be made using coins corresponding to the credit amount (1 credit corresponds to 1 coin), and the payout can be made by using bar-code attached tickets, in response to the depression of the CASHOUT button from among the operation buttons 26. If a free game has been carried out, a payout which was accumulated during the free game is paid out altogether to the player.

Next, the sub-process for the free game process at the above step S21 will be described based on FIG. 12. FIG. 12 is a flow chart of a sub-process program for the free game process in the slot machine 1 according to the present embodiment.

First, at step S31, the main CPU 52 executes a symbol lottery process for the free game in which a symbol to be positioned on the main liquid crystal panel 11B is selected by lottery. The substantial processing method of the lottery process is similar to the symbol lottery process for the base game at the above S13, therefore a detailed description is omitted.

Next, at step S33, the main CPU 52 carries out a reel rotation process. Specifically, the reels 13 through 17 start rotating and the respective symbol columns positioned in the respective reels 13 through 17 are displayed in a scrolled manner at a predetermined speed.

At S33, the main CPU 52 displays the doors 47 as characters for covering symbols to be displayed on the main liquid crystal panel 11B on the respective symbol display areas 32 to 46 (see FIG. 1(2)). Then, the displayed doors 47 cover the symbols being displayed so as to make the symbols invisible to the player.

At S34, the main CPU 52 stops rotation of the reels 13 to 17 in turn, starting from the left, and then displays one symbol on each of the symbol display areas 32 to 46, after the lapse of a predetermined period of time. As a result, the symbol combinations determined at the above-mentioned S31 is displayed on the symbol display areas 32 to 46 of the main liquid crystal panel 11B in a matrix. However, the displayed symbols are not invisible to the player, covered with the doors 47.

At S35, the main CPU 52 judges whether or not a symbol selection operation has been made by the player. More specifically, the main CPU 52 judges whether or not the player has selected one symbol for each of the rows (three symbols in total) from among the 15 symbols covered with the doors 47, based on a detection signal from the touch panel 18.

Then, if it is judged that the player has selected symbols (S35: YES), the main CPU 52 makes the doors 47 covering the three symbols selected by the player undisplayed so as to make the selected three symbols visible. Further, the main CPU 52 changes the remaining 12 symbols not selected by the player to the same kinds of the symbols as the selected symbols positioned on the respective rows (S36). On the other hand, if it is judged that the player has not selected symbols (S35: NO), the CPU 52 waits until a selection is made.

Next, at S37, the main CPU 52 also makes the doors 47 covering the remaining symbols not selected by the player undisplayed. As a result, all the symbols positioned become visible to the player. As a result, the positioned symbols display on the main liquid crystal panel 11B in such a manner that kinds of the symbols are visible.

Then, at step S38, the main CPU 52 carries out a winning determination process in which a determination is made whether or not the symbol combination positioned on the main liquid crystal panel 11B is any of the winning combinations for which any of the payouts is awarded.

If it is determined at step S38, that the winning combination has been established (S39: YES), the flow shifts to step S40. Alternatively, if it is determined that the winning combination has not been established (S39: NO), the flow shifts to step S43.

At step S40, the main CPU 52 calculates the payout based on the winning combination thus established. For instance, if a predetermined number or more of the same kind of symbols have been positioned, as shown in FIG. 5, a payout is calculated in accordance with the kind of symbol and the number of positioned symbols.

Next, at step S41, the main CPU 52 sends a notification to the player by displaying the kind of the established winning combination and the contents of the payout with respect to the main liquid crystal panel 11B.

Next, at step S42, the main CPU 52 accumulatively stores a payout corresponding to the winning combination established in the current game in the RAM 53, based on the calculation results at the above-described step S40. The payout thus stored is awarded to the player altogether, after the free game ends (S22).

Then, at step S43, the main CPU 52 determines whether or not the free game completion condition has been satisfied. The free game completion condition in the slot machine 1 according to the present embodiment includes five times of free-game execution after shifting to the free game.

If it is determined that the free game completion condition has been satisfied (S43: YES), the game mode switches from the free game to the base game, and then, the flow shifts to step S22. Alternatively, if it is determined that the free game completion condition is not satisfied (S43: NO), the flow returns to step S31 at which the free game is then executed.

As explained above, in the slot machine 1 of the present embodiment, if a free-game shift trigger is established in a base game (S19: YES), a free game is executed (S21). When the free game is started, the main CPU 52 displays the doors 47 on the respective symbol display areas 32 to 46, as characters for covering the symbols (S33). Additionally, the CPU 52 allows the player to select one symbol for each of the rows from among the 15 symbols positioned after the rotation of the reels 13 to 17 has been stopped. Next, the CPU 52 changes the remaining symbols not selected to the same kinds of symbols as the selected symbols positioned on the respective rows (S36). Then, the CPU 52 awards a prize based on the symbol combination after the symbols have been changed (S22). Accordingly, it becomes possible to allow a player's operation to intervene in determination of symbols to be finally positioned on the symbol display portion 12. This makes the player feel a sense of accomplishment more with a game result. Additionally, it becomes possible to lighten the load on a processor and miniaturize the required storage area of a memory, compared with the case where a bonus game of conventional selective kind is executed.

In particular, since the contents of prize to be given in a free game executed as a bonus game are changed in accordance with the player's operation, the player feels a sense of accomplishment more with the game result of the bonus game.

Also, by displaying the doors 47 as the characters for covering the symbol display areas 32 to 46, it becomes possible to allow a player to select symbols under the condition that the kinds of symbols are invisible. Thus, even if any symbols that will not bring high-value prize are displayed, the player's sense of expectancy for obtaining high-value prize is raised.

Furthermore, since the symbols are changed to the same kinds of symbols as the symbols selected by the player with respect to each row during a free game, the same kinds of symbols as the symbols selected by the player are positioned in row so that winning combination can be realized. Accordingly, the player feels a sense of accomplishment on a game result more since the player's selection affects winning of the game largely.

The present invention is not limited to the above-described embodiments and various modifications and alterations can be made thereto without departing from the scope of the present invention.

For instance, in the present embodiments, the conditions for shifting to the free game include establishment of a winning combination including a predetermined number or more of “JACK” symbols 21. However, the conditions for shifting to the free game may also include other conditions. For instance, such condition may occur unexpectedly, like a mystery.

Also, the present embodiment is configured in such a manner that a player is allowed to select one symbol for each of the rows (three symbols in total) from among 15 symbols once positioned on the symbol display portion 12 during a free game. However, symbols may be selected in such a manner that one symbol is selected with respect to each symbols positioned in a vertical direction, that is, column direction (five symbols in total). Then, the remaining symbols not selected may be changed to the same kinds of symbols as the selected symbols on the respective columns.

Also, the doors 47 are used for characters for covering symbols. However, other characters may be used while they can cover symbols. For example, fusuma (papered sliding door) or a person may be used.

The present invention is not limited to video reels only, but is also applicable with respect to slot machines using mechanical reels. For instance, the slot machine 201 shown in FIG. 17 is a so-called hybrid-type slot machine having a heretofore known transparent liquid crystal panel installed at a front face of the plurality of mechanical reels which are rotatably supported, and a game is carried out therein by displaying images of the respective symbols positioned on the outer periphery of the mechanical reels, through the transparent liquid crystal panel.

The slot machine 201 has three reels, namely, a left reel 203, a center reel 204 and a right reel 205 which are rotatably supported. The respective reels 203 through 205 have symbol columns drawn on their outer periphery, each symbol column being made up of a plurality of symbols. Further, the respective reels 203 through 205 have, at a front side thereof, a main liquid crystal panel 202 which is made up of a heretofore known transparent liquid crystal panel provided in the main door. Here, the main liquid crystal panel 202 has three display windows 206, 207, and 208 formed therein, the back faces thereof being visible.

In the above-described slot machine 201, the base game and the free game may be carried out employing the reels 203 through 205.

Also, the doors 47 as the characters for covering the symbol displays in the main liquid crystal panel 202, and the changing of the symbols may be carried out displaying the symbols after changed in the main liquid crystal panel 202.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A slot machine comprising:
a display that displays a symbol;
an operation unit that accepts a player's operation; and
a processor that executes processes as follows:
(a) a process of positioning a plurality of symbols in a matrix on the display in such a manner that kinds of the plurality of symbols are invisible;
(b) a process of selecting any symbol from the plurality of symbols positioned in accordance with the player's operation accepted by the operation unit;
(c) a process of changing other symbols positioned on a same row or a same column as a selected symbol to a same kind of symbols as the selected symbol; and
(d) a process of displaying the plurality of symbols positioned on the display in such a manner that kinds of the plurality of symbols are visible.

2. A slot machine comprising:
a display that displays a symbol;
an operation unit that accepts a player's operation; and
a processor that executes processes as follows:
(a) a process of executing a bonus game if a predetermined condition is satisfied during a base game;
(b) a process of positioning a plurality of symbols in such a manner that kinds of the plurality of symbols are invisible during the bonus game;
(c) a process of selecting any symbol from the plurality of symbols positioned, based on the player's operation accepted by the operation unit;
(d) a process of changing other symbols positioned on a same row or a same column as a selected symbol to a same kind of symbols as the selected symbol; and
(e) a process of displaying the plurality of symbols positioned on the display in such a manner that kinds of the plurality of symbols are visible.

3. A slot machine comprising:
a display that includes symbol display areas for displaying symbols, the symbol display areas being arranged in a matrix;
an operation unit that accepts a player's operation; and
a processor that executes processes as follows:
(a) a process of executing a bonus game if a predetermined condition is satisfied during a base game;
(b) a process of displaying characters for covering the symbol display areas during the bonus game;
(c) a process of positioning a plurality of symbols on the symbol display areas in such a manner that kinds of the plurality of symbols are invisible, while the symbol display areas are covered with the characters;
(d) a process of selecting any symbol from the plurality of symbols positioned, based on the player's operation accepted by the operation unit;
(e) a process of changing other symbols positioned on a same row or a same column as a selected symbol to a same kind of symbols as the selected symbol; and
(f) a process of displaying the plurality of symbols positioned on the display in such a manner that kinds of the plurality of symbols are visible by making the characters undisplayed.

4. The slot machine according to claim 1, wherein
the processor selects one symbol with respect to each row from among the plurality of symbols positioned on the display, based on the player's operation accepted by the operation unit, in carrying out the process (b).

5. The slot machine according to claim 1, wherein
the processor selects one symbol with respect to each column from among the plurality of symbols positioned on the display, based on the player's operation accepted by the operation unit, in carrying out the process (b).
